(19) United States
(12) Patent Application Publication
(10) Pub. No.: US 2010/0078464 A1
(43) Pub. Date: Apr. 1, 2010

(54) Wire bonding apparatus and ball forming method

(75) Inventor: Shinichi Nishiura, Musashimurayama-shi (JP)

Correspondence Address: QUINN EMANUEL;KODA & ANDROLIA, 865 S. FIGUEROA STREET, 10TH FLOOR, LOS ANGELES, CA, 90017, US

(73) Assignee: Kabushiki Kaisha Shinkawa

(21) Appl. No.: 12/286,641

(22) Filed: Oct. 1, 2008

(51) Int. Cl. B23K 31/02; B23K 3/08

(52) U.S. Cl. 228/220; 228/18

(57) ABSTRACT

A wire bonding apparatus including a capillary having a through-hole through which a wire is inserted; an inert gas feed section for feeding inert gas containing reducing gas to a region on the tip end side of the bonding tool; and a gas blowing nozzle for blowing out inert gas containing reducing gas along a base end surface of the capillary including an opening of the through-hole. The pressure in the through-hole is made lower than the ambient pressure by the gas blown out of the gas blowing nozzle toward the opening of the base end of the capillary, so that the inert gas containing reducing gas blown out of the inert gas feed section flows through the tip end into the through-hole, thus preventing oxidation of the part of the wire inside the through-hole of the capillary.

### BACKGROUND OF THE INVENTION

The present invention relates to a structure of a wire bonding apparatus and to a method for forming a ball at the tip end of a wire.

In semiconductor manufacturing processes, wire bonding apparatuses are often used to provide metal wire connections between a semiconductor die and a lead frame. In such wire bonding apparatuses, gold wires are used as connecting wires. However, with the recent demand for higher-speed and lower-cost semiconductors, metal wires made of other materials than gold, such as copper, are increasingly used as connecting wires because of its capability of higher-speed signal processing at lower cost.

Metal wires such as copper wires are likely to be superficially-oxidized. Particularly, in wire bonding where the tip end of a wire is heated and melted by, for example, electrical discharge and formed into a ball shape for bonding, the heating for ball forming can cause the tip end of the wire to be oxidized, resulting in a problem of deterioration in bonding quality between balls and pads on a semiconductor die. In order to overcome this problem, there has been a method for feeding inert gas to a ball forming region. However, this method has a problem that, upon ball forming, horizontal feeding of inert gas can affect the spark between the wire and discharge electrode (see Japanese Unexamined Patent Application Publication No. Hei 8-55869, for example).

Hence, a method has been proposed in which inert gas is blown through the upper end of a capillary in the axial longitudinal direction of the capillary so as to be fed to the ball forming region along the side surface and through a wire through-hole of the capillary, so that balls are formed by electrical discharge under the inert gas atmosphere (see Japanese Unexamined Patent Application Publication No. Hei 8-55869, for example).

In another proposed method, an inert gas feed pipe is provided at the base end portion of a capillary, and the tip end of a wire that extends at the tip end of the capillary is formed in a ball shape by the spark formed between an electrode and the wire while inert gas is being fed to the tip end of the wire through the wire through-hole of the capillary (see Japanese Examined Patent Application Publication No. Sho 61-24821, for example).

However, since metal wires such as copper wires used in wire bonding have a higher melting temperature than gold wires, higher temperature heating is required to melt such metal wires into balls. Moreover, since such metal wires have a higher thermal conductivity than gold wires and further are more likely to be oxidized when heated in the air, metal wires can be oxidized from the tip end portion thereof to the portion inside a capillary. This portion of the wire is, however, to be bonded onto a lead, accordingly, deterioration in bonding quality would occur between balls and pads and therefore between wires and leads as well.

In contrast, capillaries for use in wire bonding have a cylindrical base end to be fitted to a bonding arm and a tapered tip end with a smaller diameter toward the tip end for bonding. Capillaries also have a through-hole through which a wire is inserted, and the diameter of the through-hole, though varies depending on the diameter of wires to be used, is about 1 mm on the base end side, while about 40 to 50 μm on the tip end side in the case of frequently used wires with a diameter of about 25 μm, whereby the clearance between the inner surface of the through-hole and the outer surface of the wire is often 10 to 20 μm.

When, as described in Japanese Unexamined Patent Application Publication No. Hei 8-55869, inert gas is blown onto the upper end of a capillary so as to enter the through-hole, it is necessary that the pressure difference between the gas pressure in the through-hole on the upper end side of the capillary and the gas pressure at the tip end of the capillary is greater than the pressure loss when passing through the narrow clearance between the through-hole and the wire at the tip end of the capillary. However, even if inert gas can be blown onto the upper end of a capillary so as to enter the through-hole as in the related art described in Japanese Unexamined Patent Application Publication No. Hei 8-55869, gas flows outside the capillary and thereby the gas pressure in the through-hole on the upper end side of the capillary cannot be increased effectively, resulting in a problem that effective inert gas flow cannot be formed in the through-hole. In order to solve this problem, the flow rate of gas can be increased so as to increase the gas pressure. However, increasing the flow rate of gas can cause bulk gas flow in the ball forming region at the tip end of the capillary, destabilizing the ball forming by electrical discharge. For this reason, it is not preferable to excessively increase the flow rate of gas.

In addition, when the wire is heated to be formed into a ball, gas around the wire in the through-hole of a capillary is also heated at the same time and becomes lighter and as a result tends to rise in the direction opposite to that of the blowing of inert gas. This results in a problem that the inert gas is less likely to flow into the through-hole of the capillary when the wire is heated. Further, it is often the case that reducing gas such as hydrogen is mixed into the inert gas. However, such mixed gas, which has a smaller specific gravity than air, tends to rise. This results in a problem that the inert gas is still less likely to flow into the through-hole of the capillary if lighter-than-air mixed gas is used as inert gas. Consequently, the related art described in Japanese Unexamined Patent Application Publication No. Hei 8-55869 does not solve the problem of non-effective inert gas flow in the through-hole of a capillary. In other word, the capillary cannot be filled with inert gas, whereby the inserted portion of the wire is heated and thereby oxidized, deteriorating the bonding quality between wires and leads.

Also, in the related art described in Japanese Examined Patent Application Publication No. Sho 61-24821, since the inert gas is fed from the inert gas feed pipe provided at the base end portion of the capillary into the wire through-hole of the capillary, the inert gas does not flow to the outside of the capillary and is fed and flows into the through-hole. However, in the case of bonding with an ultrasonic vibration applied to the tip end of the capillary as is often the case in many bonding apparatuses, the gas feed pipe connected to the capillary makes it difficult to apply a desired ultrasonic vibration to the tip end of the capillary. Accordingly, the problem of the related art described in Japanese Examined Patent Application Publication No. Sho 61-24821 is that it is not applicable to such bonding apparatuses that utilize an ultrasonic vibration.

### SUMMARY OF THE INVENTION

It is an object of the present invention to prevent wire oxidation and thereby to improve bonding quality by allowing inert gas to flow effectively into a through-hole of a capillary.

The present invention is directed to a wire bonding apparatus including: a bonding tool having a through-hole through which a wire is inserted, an inert gas feed section for feeding inert gas containing reducing gas to a region on the tip end side of the bonding tool, the region including the tip end of the bonding tool and the tip end of the wire extending from the tip end of the bonding tool, the apparatus including a gas blowing nozzle for blowing inert gas containing reducing gas along the base end surface of the bonding tool including an opening of the through-hole of the bonding tool.

In the wire bonding apparatus according to the present invention, the gas blowing nozzle is preferably provided such that the gas blowing direction is approximately in parallel with the base end surface of the bonding tool and coincident with the direction toward the longitudinal center line of the bonding tool. Alternatively, the gas blowing nozzle is preferably provided such that the gas blowing direction is away from the base end surface of the bonding tool in a slanted manner and coincident with the direction toward the longitudinal center line of the bonding tool. Also, the width of a gas blowing port of the gas blowing nozzle is preferably greater than the width of the base end surface of the bonding tool in the direction perpendicular to the gas flow. Further, the gas blowing nozzle is preferably provided on a bonding head or an XY-table separately from the bonding tool and a bonding arm to which the bonding tool is provided.

The wire bonding apparatus according to the present invention preferably further includes a gas suction nozzle provided on a bonding head or an XY-table so that the suction nozzle faces the gas blowing nozzle to suck up inert gas containing reducing gas blown out of the gas blowing nozzle. Also, the apparatus preferably further includes a gas circulation path that connects the gas suction nozzle to the gas blowing nozzle; and a gas circulation fan that is provided in the gas circulation path to suck up the inert gas containing reducing gas through the gas suction nozzle and to circulate the gas to the gas blowing nozzle.

The present invention is also directed to a ball forming method for forming the tip end of a wire extending from the tip end of a bonding tool into a ball, the bonding tool having a through-hole through which the wire is inserted, this method of the present invention comprises
bringing an atmosphere of inert gas containing reducing gas to cover a region on a tip end side of the bonding tool, the region including the tip end of the bonding tool and the tip end of the wire extending from the tip end of the bonding tool, and
forming the tip end of the wire extending from the tip end of the bonding tool into a ball while inert gas containing reducing gas is blown along a base end surface of the bonding tool including an opening of the through-hole.

In the ball forming method according to the present invention, the inert gas containing reducing gas is preferably blown in a direction approximately in parallel with the base end surface of the bonding tool and coincident with the direction toward the longitudinal center line of the bonding tool. Alternatively, the inert gas containing reducing gas is preferably blown in a direction away from the base end surface of the bonding tool in a slanted manner and coincident with the direction toward the longitudinal center line of the bonding tool. Also, the blown inert gas containing reducing gas is preferably sucked up. Further, the sucked up inert gas containing reducing gas is preferably circulated and blown out again.

The present invention exhibits an effect of preventing wire oxidation and thereby improving bonding quality by allowing inert gas to flow effectively into the through-hole of a capillary.

### BRIEF DESCRIPTION OF THE DRAWINGS

FIG. 1 is an elevational view showing the configuration of a wire bonding apparatus according to an exemplary embodiment of the present invention;

FIG. 2 is a plan view showing the configuration of the wire bonding apparatus according to the exemplary embodiment of the present invention;

FIG. 3 is a perspective view showing the configuration of the wire bonding apparatus according to the exemplary embodiment of the present invention;

FIG. 4 is an elevational view showing the configuration of a wire bonding apparatus according to another exemplary embodiment of the present invention; and

FIG. 5 is an elevational view showing the configuration of a wire bonding apparatus according to still another exemplary embodiment of the present invention.

### DESCRIPTION OF THE EXEMPLARY EMBODIMENTS

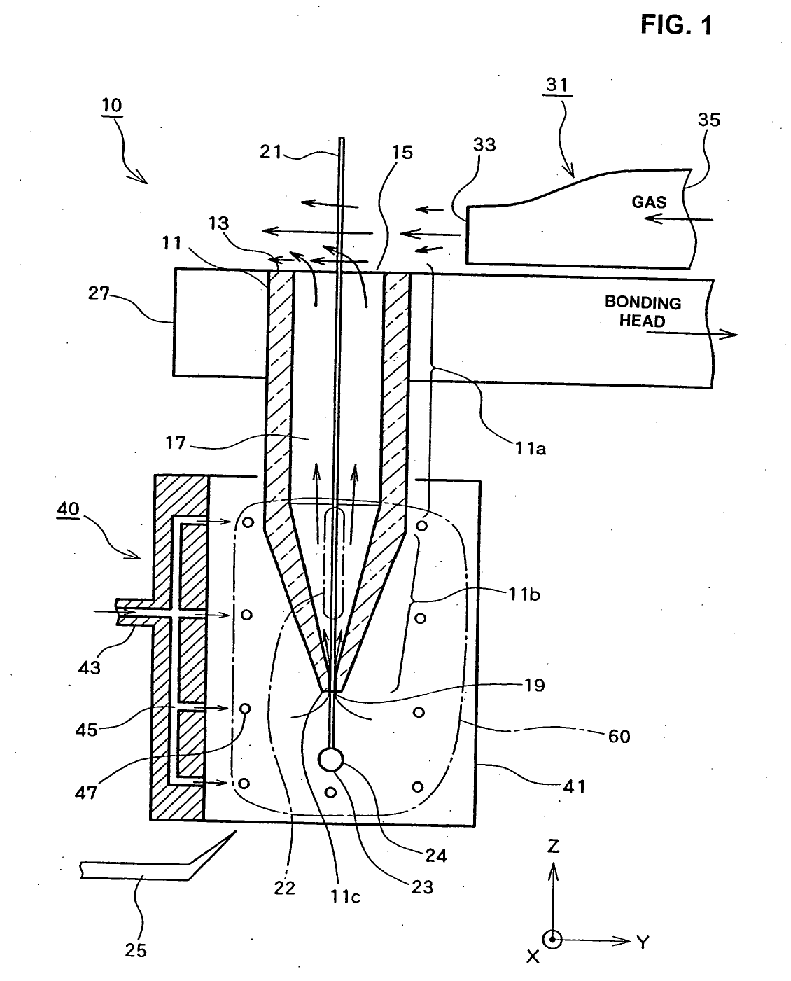

Exemplary embodiments of the present invention will be hereinafter described with reference to the accompanying drawings. As shown in FIG. 1, a wire bonding apparatus 10 according to an exemplary embodiment of the present invention includes: a bonding arm 27; a capillary 11 as a bonding tool provided on the bonding arm 27; an inert gas feed section 40 for feeding inert gas containing reducing gas to a region 60 on the tip end side of the bonding tool, the region including a tip end 11c of the capillary and a tip end 23 of a wire extending from the tip end 11c of the capillary; a discharge electrode 25 for generating a spark to the tip end 23 of the wire to heat and form the tip end 23 of the wire into a ball 24; and a gas blowing nozzle 31 for blowing inert gas containing reducing gas along the base end surface 13 of the capillary 11 including the opening 15 of a through-hole 17 formed in the capillary.

The bonding arm 27 is fixed to a bonding head to be driven in a Z direction by a Z-direction motor provided in the bonding head. The bonding head is configured to be driven in X and Y directions by an XY-table. As shown in FIG. 1, the Z direction is an axial longitudinal direction of the capillary 11, the Y direction lies in a plane perpendicular to the longitudinal axis of the capillary 11 and runs from the center of the capillary 11 toward the bonding head, and the X direction lies in a plane perpendicular to the longitudinal axis of the capillary 11 and is perpendicular to the Y direction. At the rear end of the bonding arm 27 opposite to the tip end where the capillary 11 is provided, an ultrasonic vibrator for applying an ultrasonic vibration to the capillary 11 is provided.

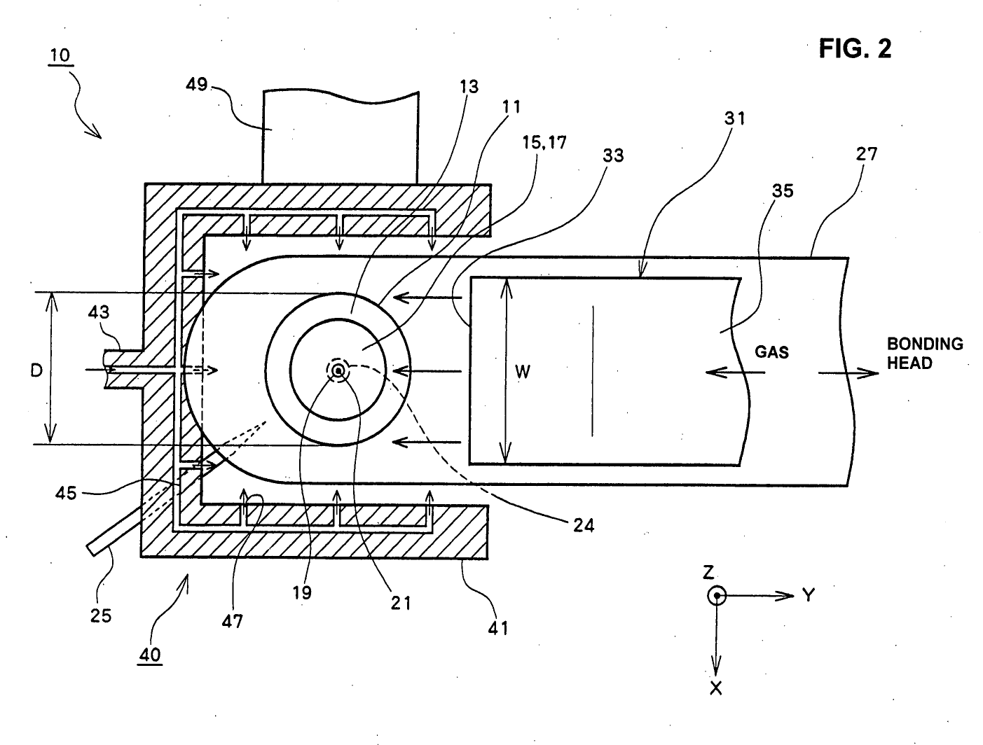

As shown in FIGS. 1 and 2, the base end side 11a of the capillary 11 has a cylindrical shape to be attached to the bonding arm 27, while the tip end side 11b has a tapered shape having a smaller diameter toward the tip end 11c of the capillary for executing bonding. The through-hole 17 provided in the capillary 11 also has a cylindrical shape through the portion corresponding to the base end side 11a, while the portion corresponding to the tip end side 11b is tapered and has a smaller diameter toward the tip end 11c of the capillary. Further, the tip end through-hole 19 at the tip end 11c of the capillary has a cylindrical shape. Although the diameters of the through-hole 17 and the tip end through-hole 19 through which a wire 21 is inserted vary depending on the diameter of the wire 21 to be used in wire bonding, the diameter of the through-hole 17 on the base end side 11a is about 1 mm while the diameter of the tip end through-hole 19 is about 40 to 50 μm in the case of, for example, using a wire 21 with a diameter of about 25 μm. With these dimensions, the clearance between the inner surface of the tip end through-hole 19 and the outer surface of the wire 21 is 10 to 20 μm. The capillary 11 is made of hard material such as ceramic or ruby and has a function of pressing the wire 21 at the tip end 11c of the capillary against electrodes on a semiconductor chip or a lead frame to form a joint between the wire 21 and each electrode.

The base end surface 13 of the capillary 11 is aligned with the upper end surface of the bonding arm 27 and lies in an XY plane perpendicular to the longitudinal center axis of the capillary 11. The base end surface 13 of the capillary 11 also includes the opening 15 of the through-hole 17.

The wire 21 is a thin metal line to be bonded by the tip end 11c of the capillary to the electrodes on the semiconductor chip or the lead frame to provide connections between the electrodes, consisting primarily of copper in the present embodiment.

As shown in FIGS. 1 and 2, the inert gas feed section 40 includes a U-shaped cover 41 (when viewed from above) that surrounds the region 60 on the tip end side of the bonding tool from three directions toward the center of the capillary 11. This region 60 includes the tip end 11c of the capillary and the tip end 23 of the wire extending from the tip end 11c of the capillary. The cover 41 is fixed to a frame or the like (not shown in the drawings) of the wire bonding apparatus 10 by a fixing arm 49.

The cover 41 includes: a gas feed port 43 through which inert gas containing reducing gas is fed from a gas feed unit not shown in the drawings; a gas passage 45 connected to the gas feed port 43 and provided inside the cover; and multiple gas blow-out openings 47 connected to the gas passage 45. The gas passage 45 and the gas blow-out openings 47 are provided in each face of the U-shaped cover 41, and inert gas containing reducing gas is blown out of the gas blow-out openings 47 toward the center of the capillary 11. The blown gas keeps the region 60 on the tip end side of the bonding tool surrounded by the cover 41 in an atmosphere of inert gas containing reducing gas. In the region 60 that is on the tip end side of the bonding tool and is kept in an atmosphere of inert gas containing reducing gas, the tip end 23 of the wire is heated by the spark caused by the discharge electrode 25.

As shown in FIGS. 1 and 2, the gas blowing nozzle 31 is mounted on the bonding head such that its gas blowing port 33 is arranged in approximately the same position in the Z direction as the base end surface 13 of the capillary 11 including the opening 15 of the through-hole 17 and approximately in parallel with the base end surface 13 of the capillary 11. The gas blowing nozzle 31 can blow inert gas containing reducing gas fed from the gas feed unit not shown in the drawings through a rear end 35 thereof toward the longitudinal center line of the capillary 11 (which is a line appearing the same as the wire 21 in FIG. 1) through the gas blowing port 33 approximately in parallel with the base end surface 13. The opening width W of the gas blowing port 33 is greater than the outside diameter D which is the width of the base end surface 13 of the capillary 11 in the direction perpendicular to the gas flow so that the inert gas can be blown along the whole surface including the base end surface 13 of the capillary 11 and the opening 15 of the through-hole 17.

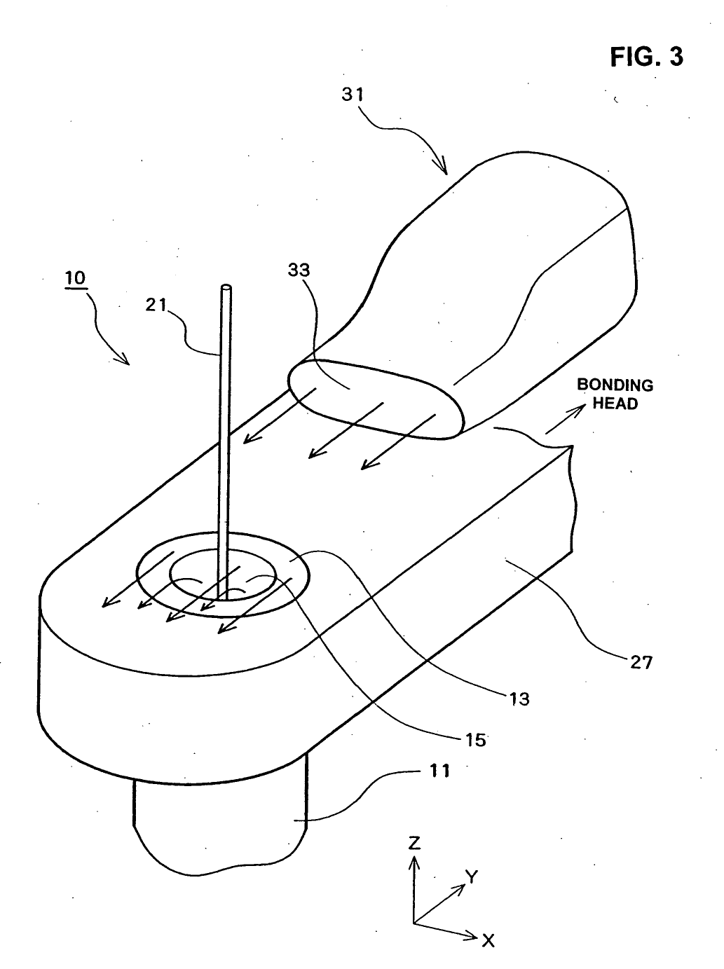

As shown in FIG. 3, the tip end of the gas blowing nozzle 31 has a flattened shape so that the inert gas containing reducing gas can flow along the base end surface 13.

The gas blowing nozzle 31 is mounted on a Z-direction drive mechanism of the bonding head so as to move in the X, Y and Z directions together with the bonding arm 27 and the capillary 11. In addition, the gas blowing nozzle 31 is mounted on the Z-direction drive mechanism of the bonding head separately from and thereby not to come into contact with the bonding arm 27 and the capillary 11. Since the gas blowing nozzle 31 is thus provided separately so as not to come into contact with the bonding arm 27 and the capillary 11, the gas blowing nozzle 31 does not affect the ultrasonic vibrator provided at the rear end of the bonding arm 27 for applying an ultrasonic vibration to the capillary 11; as a result, a desired ultrasonic vibration can be applied to the capillary 11. The gas blowing nozzle 31 can be mounted, instead of on the bonding head, on a slider of the XY-table as long as it is provided separately so as not to come into contact with the bonding arm 27 and the capillary 11. The gas blowing nozzle 31 is moved in the X and Y directions together with the bonding arm 27 and the capillary 11 if mounted on the slider of the XY-table.

In the present embodiment shown in FIGS. 1 to 3, the gas blowing nozzle 31 is provided along the Y direction, the same as the bonding arm 27. However, the gas blowing nozzle 31 can, instead of along the Y direction which is the same as the bonding arm 27, be provided, for example, perpendicularly to the bonding arm 27 so that gas is blown in the X direction as long as the gas blowing direction is approximately in parallel with the base end surface 13 of the capillary 11 and coincident with the direction toward the longitudinal center line of the capillary 11 and as long as the nozzle 31 is provided separately so as not to come into contact with the bonding arm 27 and the capillary 11.

Next an operation of forming the ball 24 at the tip end 23 of the wire using the wire bonding apparatus 10 according to the present embodiment discussed above will be described below. The capillary 11 is moved in the X and Y directions by the XY-table on which the bonding head including the bonding arm 27 is mounted, and the bonding arm 27 is moved in the Z direction by the Z-direction motor provided in the bonding head, so that the region 60 on the tip end side of the bonding tool, which includes the tip end 11c of the capillary and the tip end 23 of the wire extending from the tip end 11c of the capillary, is surrounded by the cover 41 of the inert gas feed section 40 from three directions. Then, inert gas containing reducing gas is fed from the gas feed unit not shown in the drawings to the gas feed port 43, and the gas is blown through the gas blow-out openings 47 so that the region 60 on the tip end side of the bonding tool is kept in an atmosphere of inert gas containing reducing gas.

Nitrogen or argon gas can be used as the inert gas, for example. Also, hydrogen gas can be used as the reducing gas. Further, the gas feed unit not shown in the drawings can include a mixer for mixing these gases.

Inert gas containing reducing gas is fed also from the gas feed unit not shown in the drawings to the rear end 35 of the gas blowing nozzle 31 so as to be blown out of the gas blowing port 33. The gas blown out of the gas blowing port 33 of the gas blowing nozzle 31 flows toward the longitudinal center line of the capillary 11 along the base end surface 13 of the capillary 11, flows over the opening 15 of the through-hole 17 along the opening plane, and then flows away from the longitudinal center line of the capillary 11 along the base end surface 13 of the capillary 11. This gas flow makes the pressure at the opening 15 of the through-hole 17 lower than that of the environment, whereby the gas in the through-hole 17 is sucked out through the opening 15 of the capillary 11. Since the opening width W of the gas blowing port 33 of the gas blowing nozzle 31 is greater than the outside diameter D of the base end surface 13 of the capillary 11, the gas blown out of the gas blowing nozzle 31 flows so as to cover the whole surface including the base end surface 13 of the capillary 11 and the opening 15 of the through-hole 17, and this gas flow lowers the overall pressure at the opening 15 of the through-hole 17 of the capillary 11, whereby the overall pressure inside the through-hole 17 is also reduced.

As the pressure inside the through-hole 17 of the capillary 11 decreases, the pressure inside the tip end through-hole 19 continuous thereto also decreases; as a result, the inert gas containing reducing gas that covers the region 60 on the tip end side of the bonding tool flows into the through-hole 17 through the clearance between the tip end through-hole 19 and the wire 21. If the reducing gas contained is hydrogen and the inert gas is nitrogen, the specific gravity of this mixed gas is smaller than that of air. Therefore, the mixed gas tends to flow from the tip end side to the base end side of the capillary 11 also due to the difference in specific gravity from the air therearound. The mixed gas can thus flow through the tip end through-hole 19 into the through-hole 17 relatively easily even if the amount of pressure reduction inside the through-holes 17 and 19 can be small. Then, when blowing out of the gas from the gas blowing nozzle 31 is continued, the inert gas containing reducing gas that flows into the through-hole 17 through the tip end through-hole 19 is sucked out through the opening 15 to flow away from the longitudinal center line of the capillary 11 together with the gas blown out of the gas blowing nozzle 31. Thus, blowing gas from the gas blowing nozzle 31 along the base end surface 13 of the capillary 11 and the opening 15 of the through-hole 17 allows the inert gas containing reducing gas that covers the region 60 on the tip end side of the bonding tool to flow into the through-holes 17 and 19 of the capillary 11; as a result, the part of the wire 21 inserted through the through-holes 17 and 19 of the capillary 11 is prevented from being superficially-oxidized under the atmosphere of the inert gas containing reducing gas.

The discharge electrode 25 is then energized to generate a spark between the discharge electrode 25 and the tip end 23 of the wire within the region 60 on the tip end side of the bonding tool that is covered by the inert gas containing reducing gas, thus heating the tip end 23 of the wire. The tip end 23 of the wire is, as a result, melted and formed into the ball 24 when heated to its melting temperature. In this case, although the heating at the tip end 23 of the wire causes the part of the wire 21 inside the through-holes 17 and 19 of the capillary 11 to be also heated, the inert gas containing reducing gas flows inside the through-holes 17 and 19 of the capillary 11; accordingly, surface oxidation of the wire 21 is prevented. Since the heating of the wire also causes inert gas containing reducing gas therearound to be heated, the inert gas containing reducing gas becomes more likely to flow through the tip end through-hole 19 into the through-hole 17; thus, it is possible to prevent surface oxidation of the wire 21 by allowing the inert gas containing reducing gas to flow effectively into the through-holes 17 and 19 even when the tip end 23 of the wire is heated.

It is particularly possible to effectively prevent surface oxidation of a second bonding region 22 of the wire 21 that is inside the tip end side 11b of the capillary 11 to be secondarily bonded to a lead. Accordingly, the bonding quality of the first bonding can be improved by preventing oxidation of the ball 24 and the bonding quality of the second bonding can be also improved. The arrangement that the inert gas containing reducing gas is blown out of the gas blowing nozzle 31 also simultaneously prevents surface oxidation of the part of the wire 21 exposed outside the base end surface 13 of the capillary 11.

As described above, the wire bonding apparatus 10 according to the present embodiment prevents oxidation of the wire 21 and thereby improves bonding quality by allowing inert gas containing reducing gas to flow effectively into the through-holes 17 and 19 of the capillary 11.

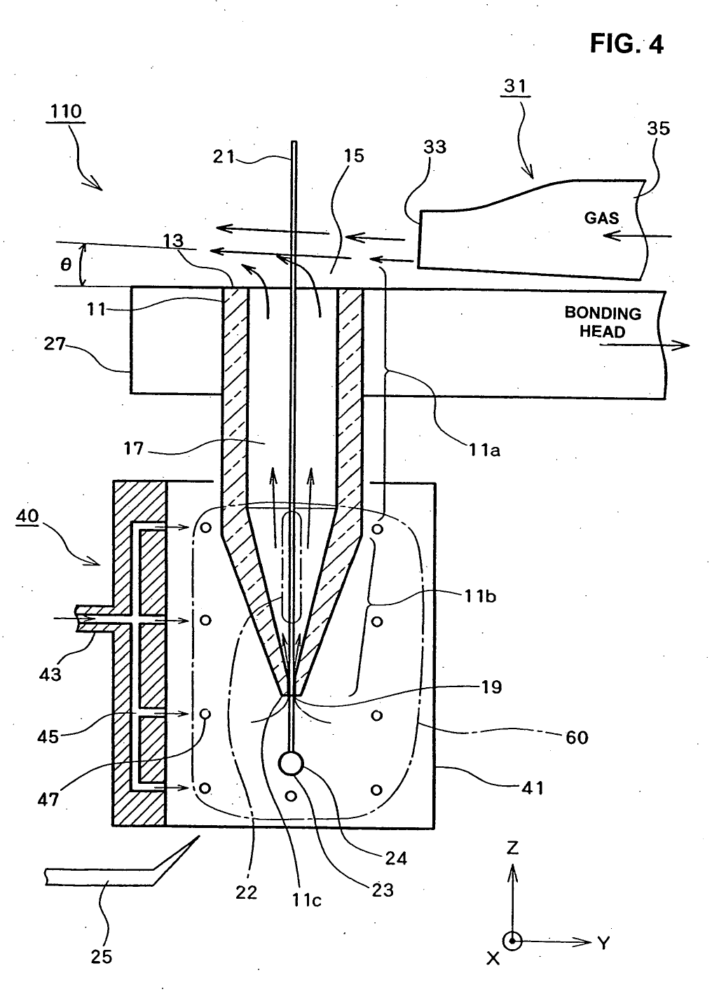

A wire bonding apparatus 110 according to another embodiment of the present invention will be described below with reference to FIG. 4. The components identical with those in the embodiment described with reference to FIGS. 1 to 3 are designated by the same reference numerals descriptions thereof will be omitted.

In the wire bonding apparatus 110, the gas blowing nozzle 31 is provided in a slanted manner at an angle of θ with respect to the base end surface 13 of the capillary 11. Since the gas blowing nozzle 31 is thus provided in a direction away from the base end surface 13 including the opening 15 of the through-hole 17 of the capillary 11, the suction force through the opening 15 of the through-hole 17 increases, so that the inert gas containing reducing gas can flow through the tip end through-hole 19 into the through-hole 17 more effectively. The angle between the gas blowing nozzle 31 and the base end surface 13 can be 45 degrees or less, for example.

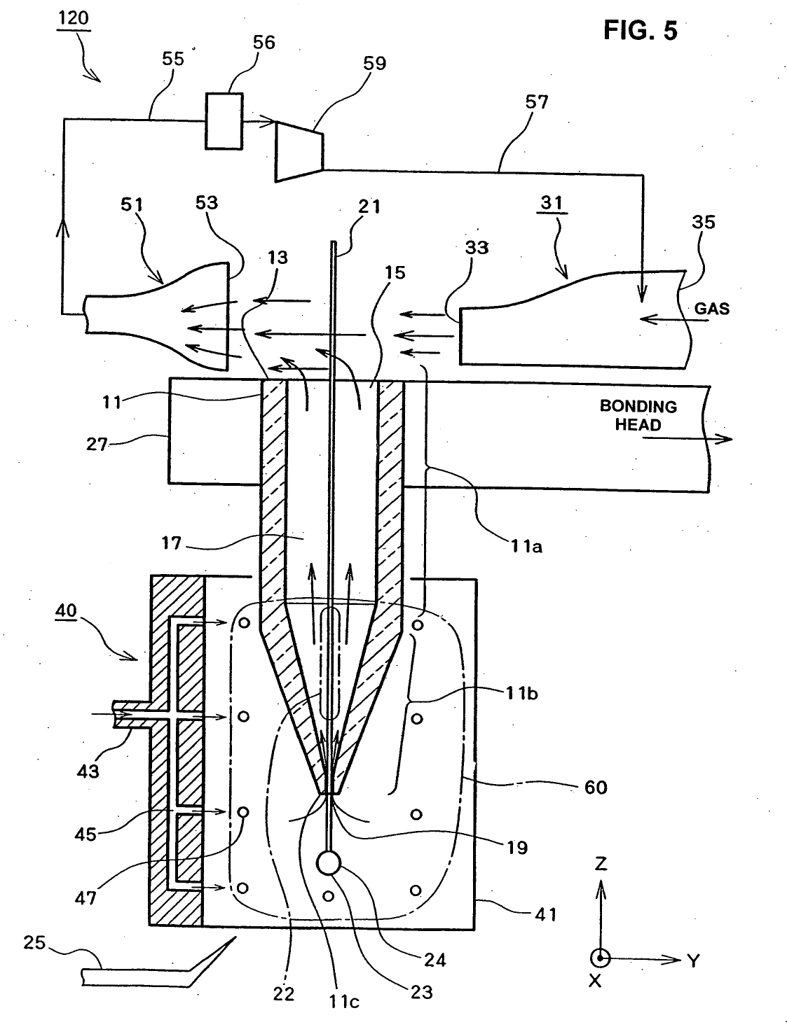

A wire bonding apparatus 120 according to still another embodiment of the present invention will be described below with reference to FIG. 5. The components identical with those in the embodiment described with reference to FIGS. 1 to 3 are designated by the same reference numerals to descriptions thereof will be omitted.

In the wire bonding apparatus 120, a gas suction nozzle 51 is provided so as to face the gas blowing nozzle 31 to suck up the inert gas containing reducing gas, which is blown out of the gas blowing nozzle 31, through a suction opening 53 thereof. The gas suction nozzle 51 is connected to a gas suction pipe 55 which is a gas circulation path, and the gas suction pipe 55 is connected to a gas circulation fan 59 through a filter 56. The outlet of the gas circulation fan 59 is connected to the gas blowing nozzle 31 through a gas outlet pipe 57 which is a gas circulation path. The suction opening 53 of the gas suction nozzle 51 is larger than the gas blowing port 33 of the gas blowing nozzle 31 so that the gas blown out and diffused through the gas blowing port 33 can be sucked up therethrough.

In the wire bonding apparatus 120 according to the present embodiment, the inert gas containing reducing gas blown out of the gas blowing nozzle 31 flows along the base end surface 13 of the capillary 11 over the opening 15 and then reaches the suction opening 53. The gas reaching the suction opening 53 is sucked up into the gas suction nozzle 51 by the gas circulation fan 59. The gas sucked up into the gas suction nozzle 51 passes through the filter 56 where foreign objects are removed and then is sucked up and compressed by the gas circulation fan to circulate through the gas outlet pipe 57 to the gas blowing nozzle 31 so that it is blown out of the gas blowing nozzle 31 again. If the gas suction nozzle 51 cannot suck up the full amount of the gas blown out of the gas blowing nozzle 31, the non-circulated gas is fed from the gas feed unit not shown in the drawings to the rear end 35 of the gas blowing nozzle 31.

The present embodiment provides the same effect as that of the embodiment described above with reference to FIGS. 1 to 3, and in addition, since the inert gas containing reducing gas can be circulated and reused, the gas consumption is reduced as a whole. Also, even if the circumjacent foreign objects flows together with the gas blown out of the gas blowing nozzle 31, the foreign objects are sucked up into the gas suction nozzle 51 together with the gas and removed by the filter 56. Therefore, the present embodiment provides a further effect that it prevents foreign objects from attaching to other parts of the wire bonding apparatus to avoid deterioration in bonding quality.

Although the present embodiment is described for the case of using the gas circulation fan 59 to suck up and circulate the gas into the gas suction nozzle 51, the gas, instead, can be sucked up and discharged by a separately installed vacuum unit or the like, thus not being circulated.

1. A wire bonding apparatus comprising:
a bonding tool having therein a through-hole through which a wire is inserted; and
an inert gas feed section for deeding inert gas containing reducing gas to a region on a tip end side of the bonding tool, the region including a tip end of the bonding tool and a tip end of the wire extending from the tip end of the bonding tool,
the apparatus comprising a gas blowing nozzle for blowing inert gas containing reducing gas along a base end surface of the bonding tool including an opening of the through-hole.

2. The wire bonding apparatus according to claim 1, wherein the gas blowing nozzle is provided
such that a gas blowing direction is approximately in parallel with the base end surface of the bonding tool and coincident with a direction toward a longitudinal center line of the bonding tool.

3. The wire bonding apparatus according to claim 1, wherein the gas blowing nozzle is provided
such that the gas blowing direction is away from the base end surface of the bonding tool in a slanted manner and coincident with the direction toward the longitudinal center line of the bonding tool.

4. The wire bonding apparatus according to claim 1, wherein
a width of a gas blowing port of the gas blowing nozzle is greater than a width of the base end surface of the bonding tool in a direction perpendicular to a gas flow.

5. The wire bonding apparatus according to claim 1, wherein the gas blowing nozzle is provided on a bonding head or an XY-table separately from the bonding tool and a bonding arm on which the bonding tool is provided.

6. The wire banding apparatus according to claim 1, further comprising a gas suction nozzle provided on a bonding head or an XY-table in such a manner as to face the gas blowing nozzle to suck up the inert gas containing reducing gas blown out of the gas blowing nozzle.

7. The wire bonding apparatus according to claim 5, further comprising:
a gas circulation path that connects the gas suction nozzle to the gas blowing nozzle; and
a gas circulation fan provided in the gas circulation path to suck up the inert gas containing reducing gas through the gas suction nozzle and to circulate the gas to the gas blowing nozzle.

8. A ball forming method of forming a tip end of a wire extending from a tip end of a bonding tool into a ball by using a wire bonding apparatus, the ball forming method comprising:
providing a wire bonding apparatus comprising:
a bonding tool having therein a through-hole through which a wire is inserted,
an inert gas feed section for feeding inert gas containing reducing gas to a region on a tip end side of the bonding tool, the region including a tip end of the bonding tool and a tip end of the wire extending from the tip end of the bonding tool; and
a gas blowing nozzle for blowing inert gas containing reducing gas along a base end surface of the bonding tool including an opening of the through-hole;
bringing an atmosphere of inert gas containing reducing gas to cover a region on a tip end side of the bonding tool, the region including the tip end of the bonding tool and the tip end of the wire extending from the tip end of the bonding tool using the wire bonding apparatus, and
forming the tip end of the wire extending from the tip end of the bonding tool into a ball while inert gas containing reducing gas is blown along a base end surface of the bonding tool including an opening of the through-hole using the wire bonding apparatus.

9. The ball forming method according to claim 8, wherein
the inert gas containing reducing gas is blown in a direction approximately in parallel with the base end surface of the bonding tool and coincident with a direction toward a longitudinal center line of the bonding tool.

10. The ball forming method according to claim 8, wherein
the inert gas containing reducing gas is blown in a direction approximately in a direction away from the base end surface of the bonding tool in a slanted manner and coincident with the direction toward the longitudinal center line of the bonding tool,

11. The ball forming method according to claim 8, wherein
the blown inert gas containing reducing gas is sucked up.

12. The ball forming method according to claim 11, wherein
the sucked up inert gas containing reducing gas is circulated and blown out again.

13. A ball forming method of forming a tip end of a wire extending from a tip end of a bonding tool into a ball, the ball forming method comprising:
providing a wire bonding apparatus comprising:
a bonding tool having therein a through-hole through which a wire is inserted,
an inert gas feed section for feeding inert gas containing reducing gas to a region on a tip end side of the bonding tool, the region including a tip end of the bonding tool and a tip end of the wire extending from the tip end of the bonding tool, and
a gas blowing nozzle for blowing inert gas containing reducing gas along a base end surface of the bonding tool including an opening of the through-hole;
bringing an atmosphere of inert gas containing reducing gas to cover a region on a tip end side of the bonding tool, the region including the tip end of the bonding tool and the tip end of the wire extending from the tip end of the bonding tool using the wire bonding apparatus, and
forming the tip end of the wire extending from the tip end of the bonding tool into a ball while inert gas containing reducing gas is blown along a base end surface of the bonding tool including an opening of the through-hole using the wire bonding apparatus.
